(19) United States
(12) Patent Application Publication
(10) Pub. No.: US 2012/0099135 A1
(43) Pub. Date: Apr. 26, 2012

(54) INFORMATION PROCESSING APPARATUS, CONTROL METHOD, AND STORAGE MEDIUM

(75) Inventor: Atsuko Ono, Kagoshima-shi (JP)

(73) Assignee: CANON KABUSHIKI KAISHA, Tokyo (JP)

(21) Appl. No.: 13/380,003

(22) PCT Filed: Jun. 28, 2010
(86) PCT No.: PCT/JP2010/004268

§ 371 Date: Dec. 21, 2011

(30) Foreign Application Priority Data
Jun. 30, 2009 (JP) 2009-155673

(51) Int. Cl. G06F 3/12

(52) U.S. Cl. 358/1.13

(57) ABSTRACT

An information processing apparatus configured to associate a device with an application by using image input device information held by an installation unit after the installation unit of the application program determines whether or not the control program for controlling the device body is installed, and a control method of the information processing system.

### TECHNICAL FIELD

The present invention relates to an information processing apparatus that associates event information with an application program operating according to the event information in an image input device, a control method of the information processing apparatus, and a program therefor.

### BACKGROUND ART

Examples of the image input device, in which information of a paper media, a negative film, or a positive film is digitalized as a document, and the document is loaded into the information processing apparatus (hereinafter referred to as the “host personal computer (PC)”) connected to the image input device so as to be communicable with the image input device in the form of image data, include an imaging scanner and a multifunction peripheral (MFP).

In some of the examples of the image input device, an application program is activated on the host PC, which is connected to the image input device, according to an event, which is generated by pressing a button of a device body, the application program requires to input an image to the control program (also referred to as the “driver program”) that controls the image input device, and the image input device is caused to input the image according to an instruction from the control program having been required to do so by the application program.

In order to realize the above-described series of operations, the Windows (registered trademark), which is an operating system (hereinafter referred to as the “OS”) produced by Microsoft Corporation, includes Windows (registered trademark) Imaging Acquisition (hereinafter referred to as the “WIA”) or Still Image Service (hereinafter referred to as the “STI”) as functions of an OS side. By using these functions, an operation when the event is generated because the button of the image input device is pressed can be defined.

In the Windows (registered trademark), the event generated when the button of the body is pressed can be registered automatically in the OS by installing a control program to the host PC after the event information is described in the INF file of the control program. Then, In the image input device, when the button of the device body is pressed by an operation of a user, event information is notified to the application program through the WIA/STI of the OS.

Similarly, the event can be registered automatically in the OS in such a manner that a command named as a co-installer is described into the INF file to execute the co-installer having been originally created by a vender. In both of the above-described method, a control program performs the registration of the event according to a specification and a function provided by the OS side. Further, an event management program, which automatically executes the application program when the event is detected, is also loaded to the OS.

The application program side can cause the OS to recognize that a program is selectable when the event is generated by declaring that the program is applicable to the event.

Accordingly, when pressing the button of the device body, a device side may only notify the event that the button was pressed to the host PC side. In the following operations, an image input is realized in such a manner that the application program on the host PC controls the device by using the control program, and reads out the image according to a normal operation by the host PC (e.g., reads out the image in a case where the image input device is an image scanner).

As a method for associating the application program to the event, which is activated when the event is generated in the image input device, U.S. Pat. No. 6,480,304 discusses a method in which an application program having been installed is detected and the application program is associated with the event when the control program is installed.

The method discussed in U.S. Pat. No. 6,480,304 is made provided that the application program has already been installed at a time when the control program is installed. This is because, a task to define the operation, when the event is generated because the button of the image input device is pressed according to the specification and the function provided by the OS side in a manner as described above, is to be performed by the control program using the INF file or the co-installer.

Conventionally, when the user performs an initial setting of the image input device, the user initially installs software including the application program from an attached media (e.g., a CD-ROM, a DVD or a memory). Thereafter, the user establishes a connection between the image input device and the host PC.

The installation of the control program is completed at a time after the image input device is connected to the host PC. At the time, an installation of the control program corresponding to the event of the input device has been completed. Therefore, association between the event and the application program can be made by the control program with ease.

However, recently, a service for automatically downloading the corresponding control program and installing it in the device (e.g., Windows (registered trademark) Update produced by Microsoft Corporation) and a service for causing the control program to be preliminary included in the operating system (i.e., pre-install driver), when the device is connected to the host PC, come to be widely spread. In other words, such a circumstance comes to be common that the control program can be used as soon as the device is connected to the host PC.

Accordingly, such an opportunity is increasing that the control program is installed in the device before the application program is installed. In this case, since the application program is not installed in the device when the control program is installed, the control program cannot associate the event with the application program. Therefore, there is a problem that a user had to manually associate the application program with the event after the application program was installed in the device.

When the event is generated, the user cannot determine which application is to be executed. As a result, there is required such a complicated operation that a list of application programs are displayed to cause the user to select an application the user desired.

### CITATION LIST

### Patent Literature

PTL 1: U.S. Pat. No. 6,480,304

### SUMMARY OF INVENTION

According to an aspect of the present invention, an information processing apparatus which is connectable to an image input device and activates an application program according to an event generated by an operation of a user in the image input device by installation of the application program and a control program and in which the control program controls the image input device according to an instruction of the application program, the information processing apparatus comprises a first installation unit configured to install the application program on an operating system of the information processing apparatus, a second installation unit configured to install the control program on an operating system of the information processing apparatus, a device information storage unit configured to store information as to the image input device to which the application program is applicable and an installation determination unit configured to determine whether or not the control program is installed in the information processing apparatus when the application program is installed by the first installation unit, wherein, in a case where the installation determination unit determines that the control program is installed in the information processing apparatus, the first installation unit registers the application program into the information processing apparatus by using information stored in the device information storage unit, regarding that the application program is an application program which is activated according to the event and wherein, in a case where the installation determination unit determines that no control program is installed in the information processing apparatus, the second installation unit registers the application program into the information processing apparatus according to a specification defined by the operating system, regarding that the application program is an application program which is activated according to the event.

According to the present invention, registration of the association between the event and the application program of the image input device, which has conventionally been capable of being performed only when the control program is installed, can be done at a time when the application program is installed in the device. Accordingly, regardless of which program is installed earlier between the control program and the application program, the event can be associated with the application program of the image input device.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a general computer, which is used as a host PC of a scanner.

FIG. 2 is a block diagram of a software configuration within the host PC according to an exemplary embodiment of the present invention.

FIG. 3A illustrates an example of a user interface (UI) of an event management program within the host PC.

FIG. 3B illustrates an example of a user interface (UI) of an event management program within the host PC.

FIG. 3C illustrates an example of a user interface (UI) of an event management program within the host PC.

FIG. 4 is a block diagram illustrating a configuration of an event-enabled application program installer and an image input device control program installer according to a prior art.

FIG. 5 is a flow chart illustrating a flow when association between the event and the event-enabled application program is successful in the prior art.

FIG. 6 is a flow chart illustrating a flow in a case where association between the event and the event-enabled application program is unsuccessful in the prior art.

FIG. 7 is a block diagram illustrating a configuration of an event-enabled application program installer according to a first exemplary embodiment and a second exemplary embodiment.

FIG. 8 is a flow chart illustrating a flow of the first exemplary embodiment.

FIG. 9 is a flow chart illustrating a flow of the second exemplary embodiment.

FIG. 10 is a block diagram illustrating a configuration of an event-enabled application program installer according to a third exemplary embodiment.

FIG. 11 is a flow chart illustrating operations of an information processing apparatus according to the third exemplary embodiment.

FIG. 12A is an example of image input device information.

FIG. 12B is an example of image input device information.

### DESCRIPTION OF EMBODIMENTS

Now, preferred exemplary embodiments of the present invention are described in detail by using a scanner as an example of an image input device with reference to drawings attached hereto.

### EXAMPLE 1

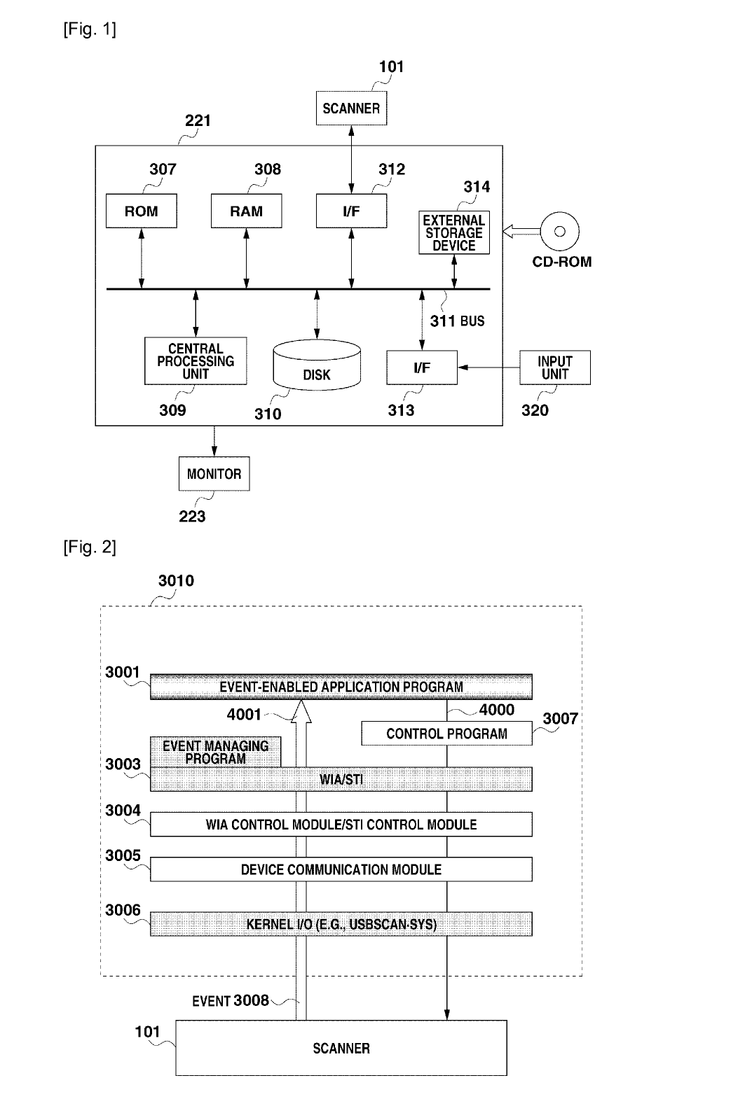

As the information processing apparatus to be used for a control of a scanner 101, a schematic configuration of a general host personal computer (PC) 221, which runs on an operating system, is briefly described with reference to FIG. 1.

The host PC 221 includes a read only memory (ROM) 307, a random access memory (RAM) 308, a central processing unit 309, a disk device 310, a bus 311, an interface (I/F) 312, an interface (I/F) 313, and an external storage device 314. The disk device 310 stores an operating system (hereinafter referred to as the “OS”) and a scanner control program.

The OS is loaded to the ROM 307, and a program such as a scanner control program is further loaded to the ROM 307. The RAM 308 provides a storage area and a work area necessary for running the control program. The central processing unit 309 performs processing according to a program held by the ROM 307.

The bus 311 serves to connect each of the components to enable transmission of data between the components. The I/F 312 connects the components to the scanner 101 so as to communicate to each other. For example, the communication is realized through a USB interface. However, the communication can also be established by employing an interface other than the above, e.g., an Institute of Electrical and Electronic Engineers (IEEE) 1394, a small computer system interface (SCSI), a local area network (LAN), and a Wireless LAN.

The I/F 313 connects the host PC 221 to an input unit 320 such as a mouse or a keyboard. Also, the external storage device 314 drives an external storage medium such as a floppy disk and a compact disk read-only memory (CD-ROM). As described above, in a case where a program is stored in the external storage medium, instead of causing the ROM 307 to preliminary hold the program, the program is read out to be downloaded to the host PC 221.

Although it is not illustrated, a driver program can, of course, be downloaded to the host PC 221 through a network by using a network connector.

Now, description is made with reference to FIG. 2. An OS 3010 runs on the host PC 211. The OS 3010 is described here provided that the OS 3010 is the Windows (registered trademark).

A relationship between the event-enabled application program (hereinafter referred to as the “application program”) 3001, the WIA/STI 3003 that is an interface program of the OS standard, an event management program 3002 corresponding to the WIA/STI, a control program 3007 that runs on the OS 3010, and the scanner 101 as the image input device, is described below.

In FIG. 2, the scanner 101 is connected to the host PC 221 through a universal serial bus (USB).

A flow to obtain an image by controlling the scanner 101 with the host PC 221 is described by using a black arrow 4000. A user can obtain the image by using a user interface of the application program 3001 normally displayed on a monitor 223.

The application program 3001 uses an application programming interface (API) based on standards of, for example, the Technology Without Any Interested Name (Twain) or the Windows Image Acquisition (WIA). The application program 3001 instructs the control program 3007 to obtain the image by designating a scan setting such as a scanner or a scanning method, a color setting, and a resolution setting. Alternatively, the application program 3001 can directly instructs the user interface of the control program 3007, which is activated from the application program, to obtain the image.

The control program 3007 issues the instruction to obtain the image to the designated scanner 101 through the WIA/STI 3003. The WIA/STI 3003 converts the API into a device driver interface (DDI), and issues the instruction to obtain the image to a WIA/STI control module 3004, which is prepared by the vender. The WIA/STI control module 3004 communicates with a device communication module 3005 by using a scan command unique to the scanner in order to transmit the scan setting.

A device communication module 3005 transmits a scan command to the scanner 101 through a Usbscan.sys 3006, which is a kernel I/O for USB. The scanner 101 reads out the image according to the received scan command. The control program 3007, the WIA/STI control module 3004, and the device communication module 3005 are illustrated independently in FIG. 2, however, they may be included in a same file as a program configuration.

In a case where the user presses the button of the body of the scanner 101 to generate an event 3008, the flow is notified by a path illustrated by a white arrow 4001, which is oriented to a reverse direction of the black arrow 4000. The event 3008 is initially notified to the Usbscan.sys 3006, which is the kernel I/O. Then, the event 3008 is notified to the WIA/STI 3003 through the device communication module 3005 or WIA/STI control module 3004.

The WIA/STI 3003 notifies about the event to the event-enabled application program 3001, which is registered as an event-enabled application program of the scanner 101.

The application program 3001 after receiving the notification of the event issues an image obtainment instruction 3009 based on a setting corresponding to the event. The subsequent flow is represented by the above-described black arrow 4000.

More than one event-enabled application program may exist on the OS 3010. Also, there may be more than one event of the scanner 101.

Therefore, the Windows (registered trademark) has an event management program including a user interface by which the user manually can select or set the event-enabled application programs. The event management program also can be prepared by each of the venders based on a specification of the WIA/STI.

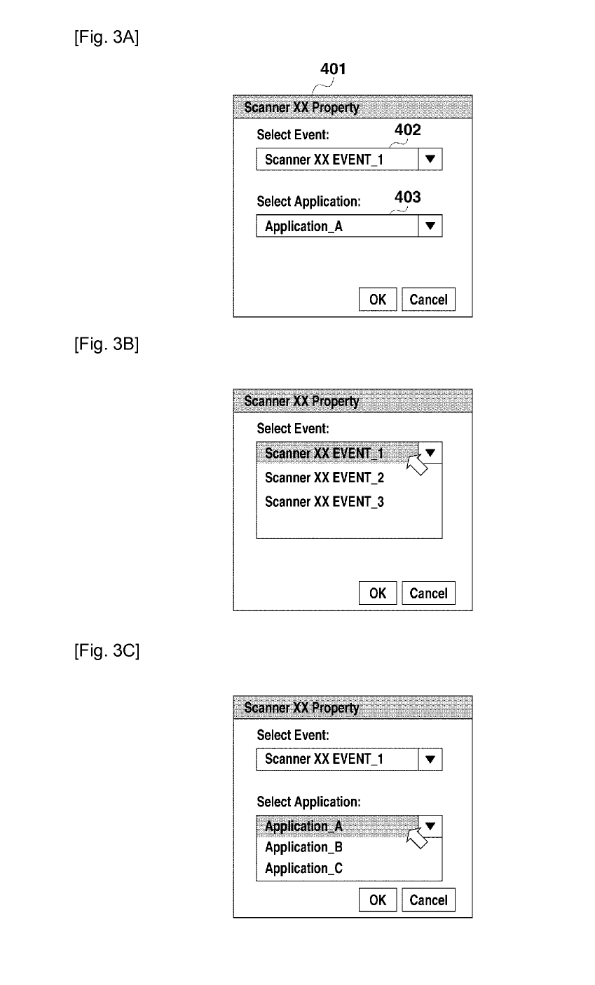

The event management program is described with reference to FIGS. 3A, 3B, and 3C. FIG. 3A illustrates an example of the user interface of the event management program.

The user selects the scanner in which the user desires to set the event, and activates a dialog 401 of the event management program. On the dialog of the event management program, there are a control 402 for selecting the event to be set and a control 403 for selecting the application program to be allotted to the selected event.

In FIG. 3A, the controls are represented in the form of a pull-down list box, however, the controls may be represented by other forms. Also, a menu to select an application program every time the event is generated may be added to the control 403 for selecting the application program.

FIG. 3B illustrates that a “Scanner XX Event_1” is selected by using a cursor as the event the user desires to set. FIG. 3C illustrates that an “Application_A” is selected as an application program applicable to the “Scanner XX Event_1”. The association result is registered and stored in the OS side, e.g., in a registry.

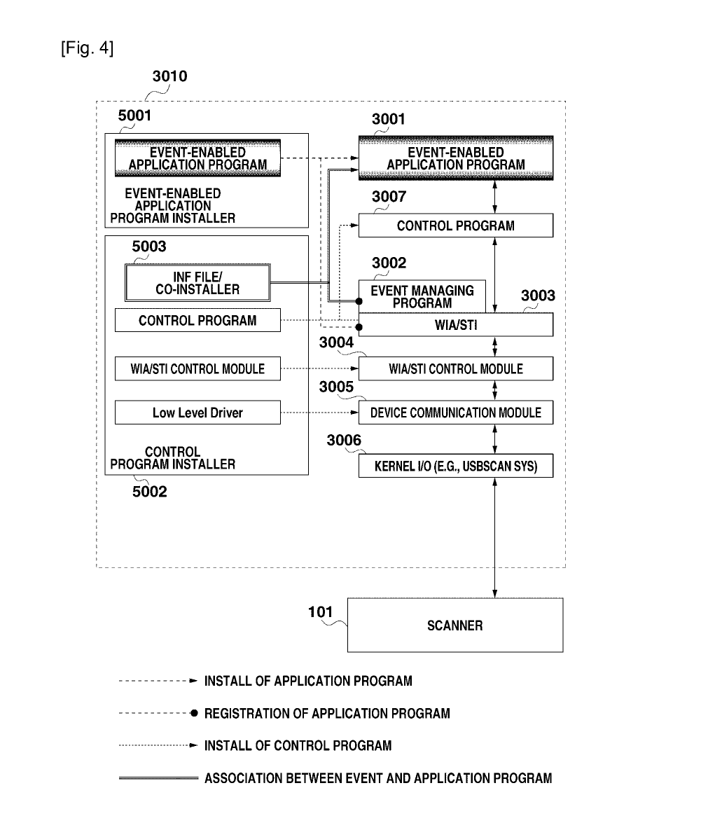

Installation operations of the conventional application program 3001 and image input device control program are described with reference to FIGS. 4, 5, and 6.

As illustrated in FIG. 4, an application program installing unit 5001 installs the event-enabled application program 3001 to the OS 3010 as well as registers a fact that the application program is an event-enabled application program to the WIA/STI of the OS.

Also, a control program installer 5002 installs the control program 3007, the WIA/STI control module 3004, and the device communication module 3005 to the OS 3010 based on contents described in a driver information file of the driver (hereinafter referred to as the “Information File (INF)”) and the co-installer.

When the installation operation is completed, thus installed control program is associated with the corresponding application program by using the INF file or the co-installer 5003. Accordingly, an application program is activated from the event generated in the image input device, thereby enabling the control program to issue an instruction to input the image to the device.

The association result is registered and stored in the OS side, e.g., a registry. Contents that is registered here is identical to the contents that is manually registered by the user by using the UI on the event management program in FIG. 3.

A detailed description is omitted here with respect to the association method of the control program with the application program by using the INF file or the co-installer since the method is in a range of the generally know art. However, such a method may be used that information of the application program is described in the INF file or that necessary information is registered in the registry by executing the co-installer, which has been uniquely created by the vender after the co-installer is described in the INF file.

The control program installer 5002 needs to hold information as to the application program such as a name of the application program in the installer as the information for performing the association processing.

As a method for holding the information, the information may be described in the INF file as described above or may be held within the co-installer in the form of a piece of information. Alternatively, information that the co-installer refers to may be held within the image input device control program installer 5002 as a setting file. Further alternatively, such a rule may be made that, provided that a specific file or a specific registry is defined on the OS, the application program installer 5001 or the application program 3001 writes information into the defined file or the defined registry.

In either one of the methods, information necessary for the association between the control program and the application program is written into the defined file or the defined registry to complete the association processing.

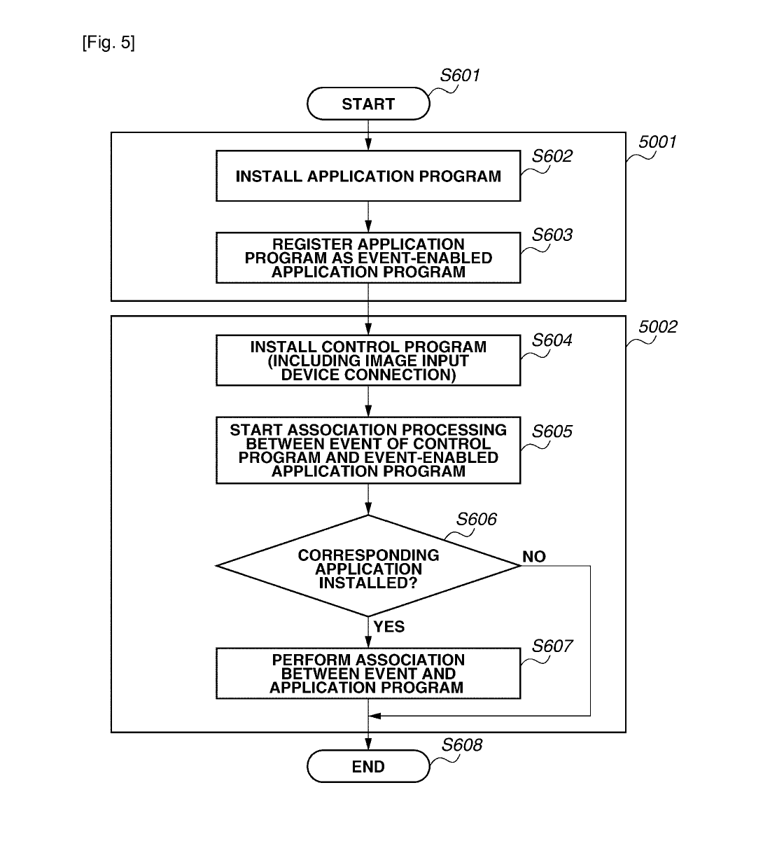

FIG. 5 illustrates a flow when the association processing between the event and the application program is successful in the conventional example. In the flow, process executed on the OS is described. In the flow, the user executes the application program installer 5001, followed by execution of the installer 5002 of the device control program.

Initially, the application program installer 5001 is executed. In step S602, the application program installer installs the application program to perform a general installation operation such as copying of a necessary program file or creation of a necessary registry.

Then, the application program installer registers itself as the event-enabled application program. In step S603, the device control program installer 5002 is executed. At this time, the device control program installer initially installs the control program and subsequently registers copies of necessary files and necessary registries such as the control program 3007, the WIA/STI control module 3004, and the device communication module 3005.

In step S604, in a case of the Windows (registered trademark), in order to complete the installation operation of this control program, the image input device is actually required to be connected to the host PC by using an interface such as a USB. In step S605, after completing the installation of the program, the association processing is started between the event of the control program and the application program. The association processing is executed by the INF file or the co-installer 5003.

In step S606, whether or not the corresponding application program to be associated has already been installed is determined. In step S606, since the corresponding application program has already been installed (YES in step S606), the processing proceeds to step S607 and the association processing is actually executed. In step S606, in a case where the application program is not installed in the scanner (NO instep S606), the association processing of step S607 is skipped. In step S608, the processing is ended.

Information for determining whether or not the corresponding application program has been installed in the device and information for executing the association processing with respect to the corresponding application program may be held, as described above, within the image input device control program installer 5002 in the form of the setting file or may be defined as the specific file or the specific registry on the OS as the reference destinations.

As described above, in a case where the image input device control program is installed in the device after the conventional event-enabled application program is installed, the association processing between the event and the application program can be normally executed.

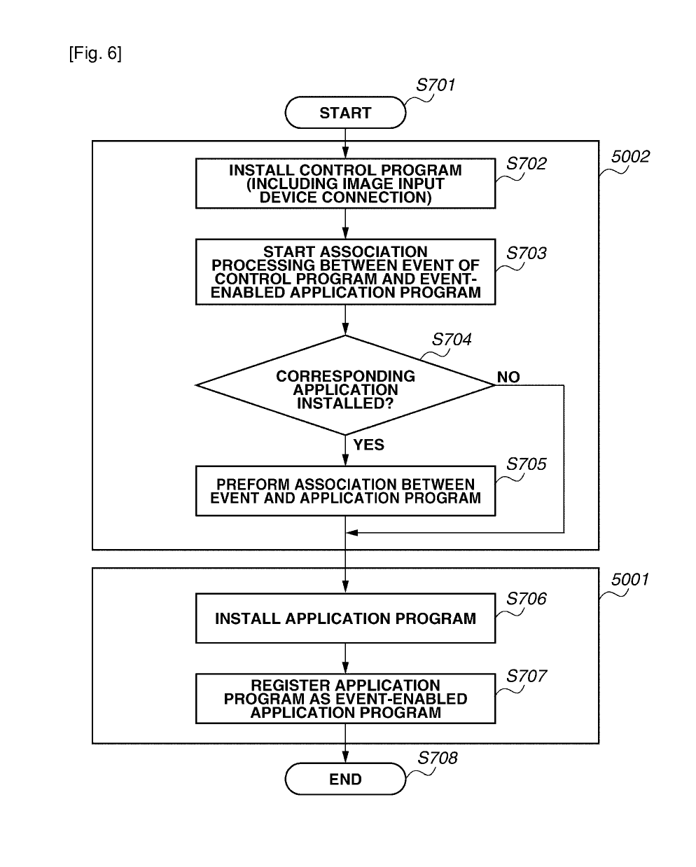

FIG. 6 illustrates a flow when the association processing between the event and the application program is unsuccessful in the conventional example.

In FIG. 6, a process to be executed on the OS is described. In the process, the user executes the installer 5002 of the control program, followed by execution of the application program installer 5001.

Initially, the control program installer 5002 is executed. The control program installer installs the control program and registers copies of the necessary files and the necessary registries such as the control program 3007, the WIA/STI control module 3004, and the device communication module 3005.

In step S702, in a case of the Windows (registered trademark), in order to complete the installation operation of this control program, it is required to actually connect the image input device to the host PC through the interface such as the USB. In step S703, after completing the installation of the control program, the association processing between the event and the event-enabled application program is started.

In step S704, whether or not the corresponding application program to be associated has already been installed is determined. In step S704, since the application program is not installed (NO in step S704), in step S705, the association processing between the event of the control program and the application program is not executed, and the processing proceeds to the next one.

In step S706, the application program installer 5001 is executed to install the application program. In step S707, the application program registers that the application program itself is the event-enabled application program, and then the processing is ended.

As described above, in a case where the event-enabled application program is installed after the conventional control program is installed, the association processing between the event and the application program is not performed.

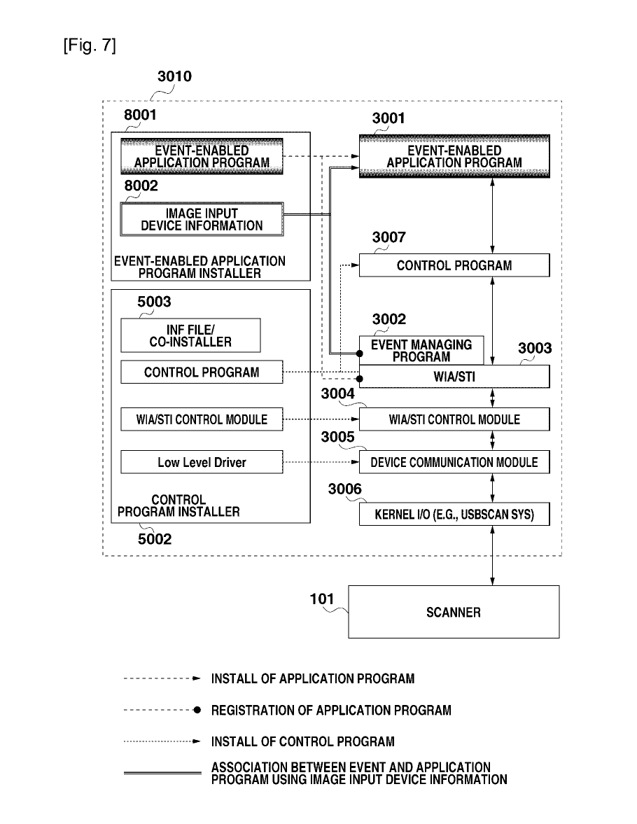

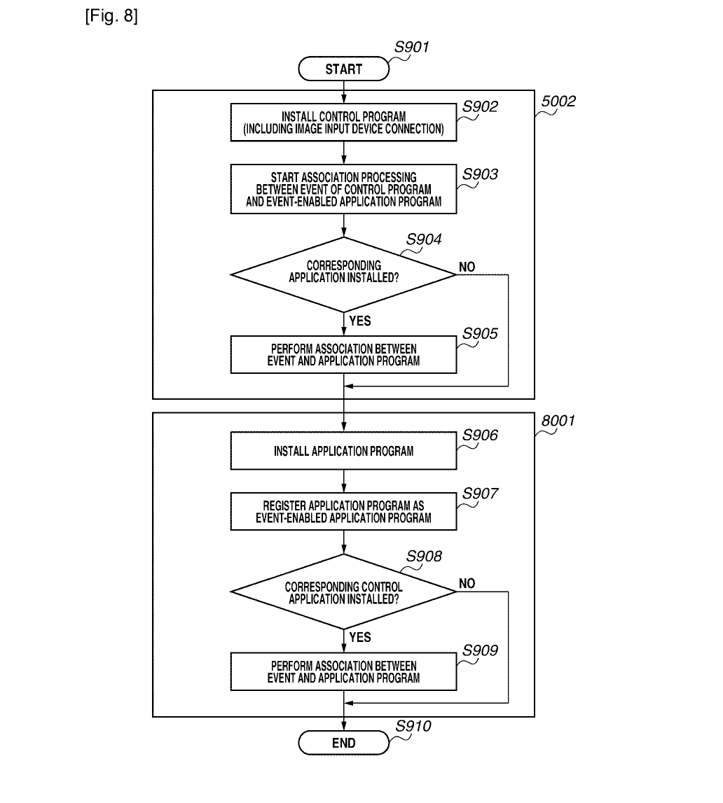

Now, the installation operation of the event-enabled application program 3001 of the present exemplary embodiment of the invention is described with reference to FIGS. 7 and 8.

An application program installer 8001 illustrated in FIG. 7 installs the application program 3001 into the OS 3010 as well as registers a fact that the application program is the event-enabled application program in the WIA/STI of the OS.

In addition to the above, the present exemplary embodiment additionally includes a unit for associating an event notification function conventionally performed by the installer of the control program with the application program, within the event-enabled application program installer 8001.

Conventionally, when the application program is installed, the image input device is not required to be specified. However, the application program installer 8001 holds image input device information 8002 to which the application program is applicable.

Information that can be recognized by the device to which the application program is applicable is required to be held in this image input device information. Examples of the information that can be recognized by the device include a vender identification (VID) or a product identification (PID), which is described in a Device Descriptor of the USB.

The information is not necessarily held by the image input device side, but information such as a name of the control program can be used as the information as far as the information can be recognized by the device.

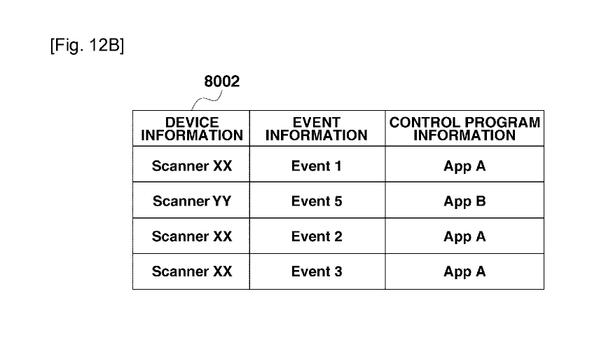

FIG. 12A illustrates a schematic view of image input device information 8002. The image input device information 8002 holds any one of or all of the device information, the event information, or the control program information as the information that can be recognized by the device to which the application is applicable.

The application program installer 8001 registers that the installation of the application program and the application program are event-enabled, and subsequently associates the application program itself with the control program by using the information obtained from the host PC based on information held by the image input device information 8002 or the stored information.

Accordingly, the association between the event and the application program can be realized disregarding which is installed earlier the application program or the control program.

As a specific operation of the association processing between the event and the application program, the application program installer 8001 searches the registry or the file information within the OS. In a case where the control program has already been installed in the device, the installation information of the device information, which is connected to the host PC, and the control program, which are connected to the registries and the file information are stored in the device, since the device is connected to the host PC. Therefore, the installation information thereof is to be searched.

In a case where the device information and the control program are found, whether or not the device program and the control program are the ones to which the application program is applicable is confirmed with reference to the information held by the image input device information 8002.

In a case where it is determined that the device program and the control program are the ones to which the application program is applicable and have already been installed, the device information and the control program are registered in a defined file or a defined registry by using information held by the image input device information 8002 in order to associate the application program with the event. In other words, the registration is performed in such a manner that the control program writes into the defined file or the defined registry by using the INF file or the co-installer provided by the OS.

FIG. 8 illustrates a flow in which the present invention is applied to the conventional case where the application program is installed to the device after the control program is installed, resulting in failing to associate the event with the application program. The present flow describes a process executed on the OS. At the time, the operations of the user include execution of the installer 5002 of the control program and execution of the application program installer 8001 of the present invention.

Initially, the control program installer 5002 is executed. In step S902, the control program installer installs the control program, and registers copies of the necessary files and necessary registries such as the control program 3007, the WIA/STI control module 3004, and the device communication module 3005.

In step S903, after completing the installation of the control program, the association processing between the event of the control program and the application program is started. In this case, in step S904, it is determined whether or not the application program to be associated has already been installed.

In step S904, since the corresponding application program is not installed (NO in step S904), the association processing of step S905 is not executed, and the processing proceeds to the next step. Then, the application program installer 8001 is executed. In step S906, the application program is installed into the device. In step S907, a fact that the application program itself is the event-enabled application program is registered in the device.

In step S908, whether or not the control program with which the application program is to be associated has already been installed to the device is confirmed by using the image input device information 8002 in the present exemplary embodiment. The confirmation whether or not the program has been installed is determined in such a manner that whether or not the device information corresponding to the image input device information 8002 is contained in the specific registry or the specific file information as it is described in the above in a case of the Windows (registered trademark) OS.

In this case, since the control program has already been installed (YES in step S908), the processing proceeds to step S909. In step S909, the association processing is performed between the application program itself and the event of the corresponding image input device.

The association processing is performed by registering the application program itself in the defined file or the defined registry based on the information held by the image input device information 8002 as the application corresponding to the event information of the control program in the case of the Windows (registered trademark) OS.

As described above, in the conventional configuration, the association processing was not performed between the event and the application program in a case where the event-enabled application program is installed in the device after the control program is installed.

To the contrary, in the present exemplary embodiment, the image input device information 8002 is held in the application program installer 8001. If the device control program has been installed in the device, the device information that is connected to the host PC is registered in the OS. Whether or not the device control program is installed can be determined by comparing the information of the image input device information 8002 and the device information registered in the OS. Accordingly, the association between the event of the image input device and the application program becomes possible, even when the event-enabled application program is installed after the control program is installed.

The same effect can be obtained if information as a key to be referred to in order to obtain various information necessary for the association processing is stored in the image device information 8002, and the association processing is performed by using the information to be referred to.

In a case where the device control program is installed after the conventional event-enabled application program in which the association processing is successful is installed, the determination in step S904 of FIG. 8 becomes YES. Since it is determined YES in step S904, the association processing between the event and the application program is performed in step S905.

In step S908 of FIG. 8, a determination whether or not the corresponding control program has already been installed is made within the application program installer 8001, and a result that the program has not been installed is made. Therefore, the association processing between the event and the application program of step S909 is not executed, so that no adverse effect would be produced.

As described above, without largely changing the conventional configuration, the association processing between the event and the application program can be realized without being adversely affected by the order which is installed earlier the event-enabled application or the control program.

In FIGS. 7 and 8, a case of a single event is illustrated. However, in a case where the image input device to be associated includes a plurality of events, the association processing between the event and the application program performed in step S909 may be performed repeatedly according to the number of the events.

The image input device information 8002 in this case requires the number of pieces of relative information corresponding to the number of the devices and the number of the events as they are exemplified in FIG. 12B.

In FIGS. 7 and 8, a case where only one type of image input device in which the association processing is performed in order to associate the application program with the event is described. However, in a case where there are a plurality of image input devices which the user desires to associate with the application program, steps S908 and S909 of the flow may be repeated for the number of image input devices to be associated.

In this case, as illustrated in FIG. 12B, it is necessary to include the input device information 8002 for a plurality of types of devices. Accordingly, it became possible to associate the application program itself with each of the events with respect to the plurality of types of image input devices having a plurality of pieces of event information.

### EXAMPLE 2

In the first exemplary embodiment, such an example is described that the association processing is performed between the application program and the event regardless of whether or not the association between the event and the application program has already been made at a time of installation of the event-enabled application program.

However, in the first exemplary embodiment, there is a problem that, in a case where the user intentionally associates the event notification-enabled application program with another application program, the association between the event and the application program is rewritten by the application program that is installed later.

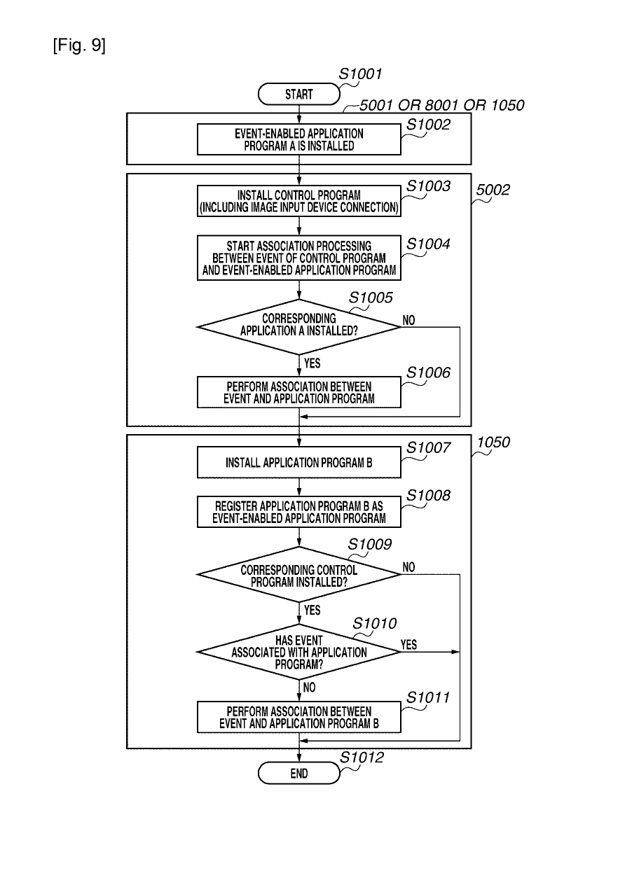

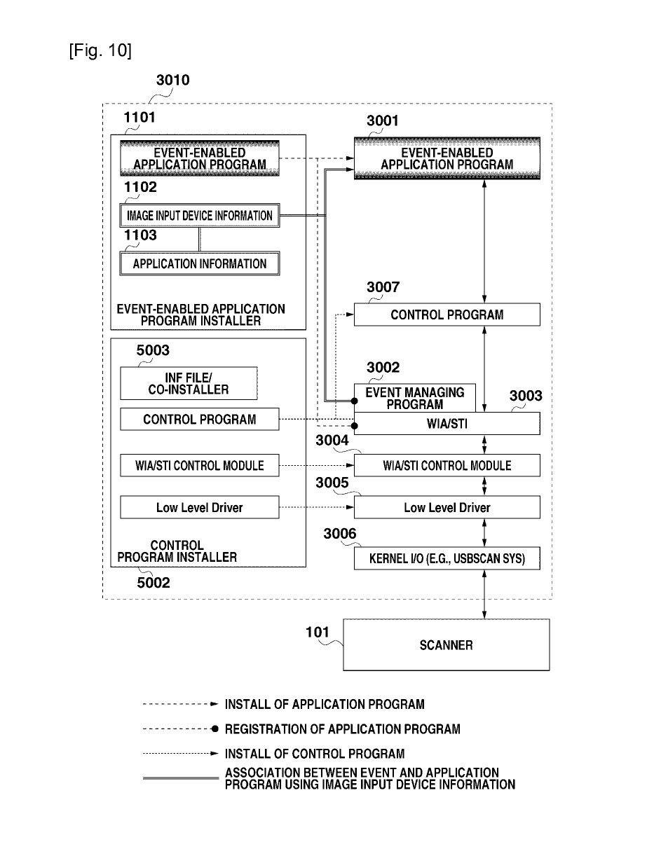

FIG. 9 illustrates such a flow that the association processing is not performed in a case where the association processing has already been made between the event and the application program at a time of installation of the application program.

The present flow illustrates a process executed on the OS. Examples of operations of the user include execution of the installer 1050 of the application program A, execution of the installer 5002 of the control program, and execution of the application program installer 1050 of the present invention.

In step S1002, it is provided that the application program A has already been installed by the event-enabled application program installer. Namely, the device is in a state that the application program A has been installed and registered as the event-enabled application program.

In step S1003, the control program is installed by the installer 5002 of the control program. In step S1004, the association processing is started between the event and the application program.

In step S1005, the control program confirms whether or not the corresponding application program A has already been installed. In step S1005, since the application program A has already been installed (YES in step S1005), the processing proceeds to step S1006. In step S1006, the association processing is executed between the event and the application program A. Accordingly, the event of the image input device is associated with the application program A.

In the present exemplary embodiment, a case where the application program B is installed is further described below. More specifically, described is a method for keeping the associated state between the image input device and the application program A in a case where the installer 1050 of the application program B is executed.

In step S1007, when the installer 1050 of the application program B is executed after step S1006 of FIG. 9, the application program B is initially installed into the device. In step S1008, the application program B is registered as an event-applicable application program.

In step S1009, the application program B confirms whether or not the corresponding control program has already been installed. The flow up to now is identical to the flow of the first exemplary embodiment. In step S1010, however, whether or not the event to which the application program B is to be associated has already been associated with another application and whether or not the association has already been registered is determined.

Determination is made by determining whether or not the association information is registered in the defined files or the defined registries. Since the association between the event and the application program A has already been made in step S1006 (YES in step S1010), the installer 105 does not perform a new association processing and the processing goes to step S1012 where the processing is ended.

In a case where the association processing is not performed between the event and the application program in step S1010 (NO in step S1010), the processing proceeds to step S1011 where the event is associated with the application program B.

As described above, in the installer 1050 of the application program B, whether or not the association processing has already been performed between the event and another application program is confirmed before the association processing, thereby enabling to keep the associated state having already made.

In FIG. 9, a case where the association processing is performed by the installer of the control program after the installation of the application program A is illustrated. However, an order of the steps before step S1006 of the flow can be changed as required. That is, in a case where the user manually performs the association processing or in a case where the installer of the application program performs the association processing according to the first exemplary embodiment of the present invention, the same effect can be obtained.

As described above, since the previous association can be maintained, such a problem can be solved, in a case where the user has intentionally designated and associated another event notification-enabled application program with the application program to be associated with the event-notification, that the association state between the event and the program intended by the user is rewritten by the installation of the application program that is installed later.

FIG. 9 illustrates a case where there is a single event. However, in a case where the image input device to be associated includes a plurality of events, the determination processing of step S1010 and the association processing between the event and the application program of step S1011 can be repeatedly performed for the number of events. In this case, the input device information 8002 is required to have pieces of information according to the number of the events.

FIG. 9 illustrates a case where there is only one type of the image input device in which the application program is associated with the event. However, in a case where there are a plurality of image input devices to be associated with the application program, steps S1009 trough S1011 of the flow are repeated for the number of the image input devices to be associated. In this case, the image input device information 8002 is required to have pieces of information corresponding to the number of the devices to be associated.

Accordingly, the application program itself can be associated with each of the events with respect to the plurality of types of image input devices having plurality of pieces of event information.

### EXAMPLE 3

In the second exemplary embodiment, such an example is illustrated that the association processing is not performed in a case where the association between the event and the event-enabled application program has already been made at the time of installation of the event-enabled application program. However, even in a case where the association with the application program has already been made, if a maker side desires to change the application program to be associated to the event due to a version-up of the application program and a change to the other application program with respect to the device the user has already purchased, the event information is required to be rewritten into a new application.

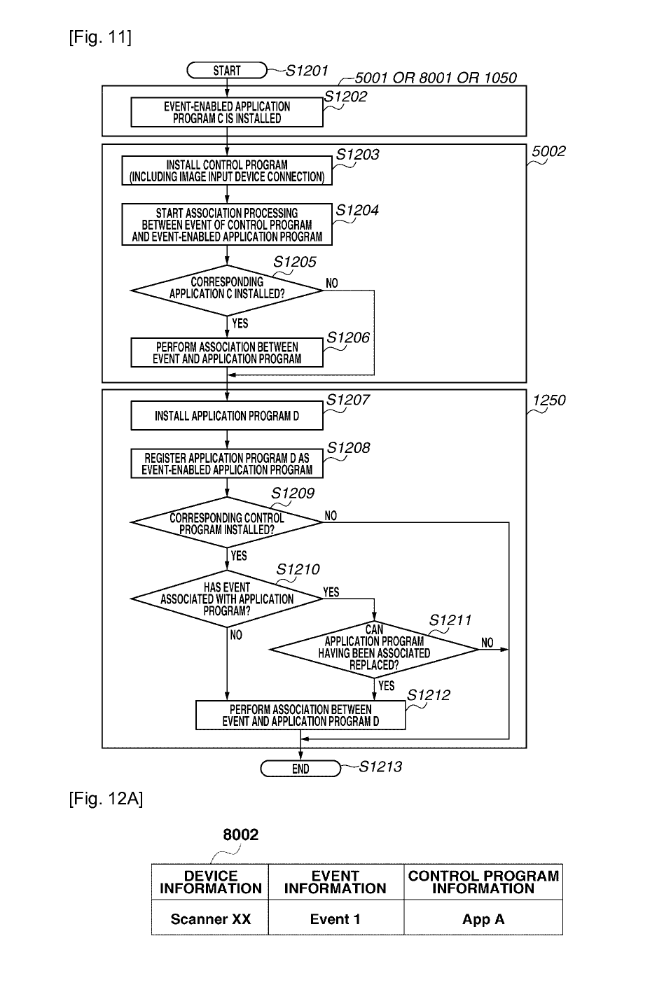

Such a case is described with reference to FIGS. 10 and 11 that, even in a case where the event has already associated with the application program, whether or not the application program, to which the association processing is set, can be updated is determined in order to replace the application program.

An event-enabled application program installer 1202 of FIG. 10 installs the event-enabled application program 3001 as well as registers that the application program is the event-enabled application program in the WIA/STI of the OS. This configuration is identical to those of the first exemplary embodiment and the second exemplary embodiment.

In the third exemplary embodiment, the event-enabled application program installer 1101 includes application information 1103 in addition to the corresponding image input device information 1102. The application information 1103 is used as an update determination unit for determining whether or not the application program can be updated when the application program has already been associated with the event.

The application information 1103 holds information of the application program, which is regarded as being set to be the event-enabled application program. The application information is information that can specify an application program, e.g., a name of the application program or a globally unique identifier (GUID), which is a unique identifier having no identical value.

In the application information, the application program can be designated individually, the application program of a version previous to the application program installer 1101 can be designated, or a wild card can be used to update all the application programs.

A flow of the third exemplary embodiment is described with reference to FIG. 11.

The present flow describes processes executed on the OS. Examples of operations of the user include execution of the application program installer, execution of the installer 5002 of the control program and execution of the application program installer 1250 of the present exemplar embodiment.

In step S1202, it is initially assumed that the application program C has already been installed in the device by the event-enabled application program installer. Any one of the above-described installers 5001, 8001, and 1050 can be used as the application program installer here. A state here is that the application program C is installed and registered as the event-enabled application program.

In step S1203, the installer 5002 of the control program installs the control program. In step S1204, the installer 5002 thereafter starts the association processing between the control program and the application program.

In step S1205, the control program confirms whether or not the corresponding application program C has already been installed. Since the corresponding application program C has already been installed here (YES in step S1205), the processing proceeds to step S1206 where the association processing is performed between the event and the application program C. Accordingly, the event of the image input device is associated with the application program C.

According to the present exemplary embodiment, in a case where an installer 1250 for an application program D is thereafter executed, if the application program C is a replaceable program, the association is updated between the image input device and the application program D.

In step S1207, when the installer 1250 for the application program D is executed, the application program D is initially installed. In step S1208, the application program D is registered as the event-enabled application program.

In step S1209, whether or not a corresponding image input control program has already been installed is confirmed. In step S1210, whether or not the event has already been associated with any of the application programs is confirmed. Since the event has already been associated with the application program C in step S1208 (YES in step S1210), the processing proceeds to step S1211.

In step S1211, whether or not the application program C having been associated can be replaced is determined. Here, in this determination, application information 1103 held by the application installer 1101 is used to confirm whether or not replaceable application information is registered as the event information of the corresponding control program.

In a case of the Windows OS, the registry in which the application program corresponding to the event information of the control program is registered is searched. Then, the application program registered in the registry is compared with the application information held by the application information 1103 and thereby whether or not the application program corresponds to the application information is determined.

Further, the application information can also be used in holding the information that is regarded as a key for obtaining information that specifies the application program from the other registries or files within the OS.

In a case where it is determined that the application program C can be replaced by the application program installer 1250 in step S1211 (YES in step S1211), the processing proceeds to step S1212. In step S1212, the association processing is executed between the event of the image input device and the application program D to update the application information.

In a case where it is determined that the replacement is not possible in step S1211 (NO in step S1211), the association processing is not executed and the processing is ended. Therefore, the installation of the application program D can be ended while the association between the application program C and the event is kept as it is.

In a case where association between the event and the application program is not made in step S1210 (NO in step S1210), the processing proceeds to step S1212. In step S1212, the association processing is performed between the event and the application program D.

As described above, in the installer 1250 for the event-enabled application program D, in a case where the corresponding event has already been associated with the application program, the association between the event and the event-enabled application program can be updated, as required, by determining whether or not the application program having been set is replaceable.

FIG. 11 illustrates a case where the association processing is performed by the installer for the image input device control program after the installation of the application program C. However, an order of the steps in the flow before step S1206 can be changed, as required. Also, in a case where the user manually performs the association processing, and also in a case where the installer of the application program performs the association processing according to the exemplary embodiment of the present invention after the installation of the image input control program, a similar effect can be obtained.

For example, in a case where the third exemplary embodiment is used at a time of version-up or changing the application program, the application program before it is upgraded and application program before it is changed can be designated as the replaceable application program.

Accordingly, in a case where the event is associated with another application program according to the user's intention, the setting is maintained. The registration of the association can be updated with a new application program only for the user who has associated the event with the event-enabled application program according to a proposal of the vender (i.e., as set by the installer).

FIG. 11 illustrates a case where there is only one event. However, in a case where the image input device to be associated includes a plurality of events, the processing from the determination processing performed in steps S1210, S1211, and S1212 through the association processing between the event and the application program can be repeated for the number of events. In this case, the image input device information 1102 is required to have pieces of information according to the number of the corresponding events.

Also, in FIG. 11, a case where there is only one type of image input device in which the application program is associated with the event is illustrated. However, in a case where there are a plurality of image input devices to be associated with the application program, steps S1209 through S1212 of the flow are repeated for the number of the image input devices to be associated. In this case, the image input device information 1102 is required to have pieces of information according to the number of the corresponding devices.

Accordingly, it becomes possible to associate the application program itself with each of the events with respect to the plurality of types of image input devices having a plurality of pieces of event information. The image input device is exemplified by the scanner or the multifunction peripheral. However, the examples of the image input device is not limited to those but may includes a digital camera and an image input device, which can transmit an image, i.e., an image data or received data of the a facsimile within a memory inserted into a memory slot installed in the device body of the multifunction peripheral, to the host PC through the WIA/STI.

The present invention is applicable to a program, which controls an input device according to the present invention, and also a medium in which the program is stored. Further, the present invention is not restricted by a kind of the OS.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-155673 filed Jun. 30, 2009, which is hereby incorporated by reference herein in its entirety.

1. An information processing apparatus, which is connectable to an image input device and activates an application program according to an event generated by an operation of a user in the image input device by installation of the application program and a control program, and in which the control program controls the image input device according to an instruction of the application program, the information processing apparatus comprising:
a first installation unit configured to install the application program on an operating system of the information processing apparatus;
a second installation unit configured to install the control program on the operating system of the information processing apparatus;
a device information storage unit configured to store information as to the image input device to which the application program is applicable; and
an installation determination unit configured to determine whether or not the control program is installed in the information processing apparatus when the application program is installed by the first installation unit;
wherein, in a case where the installation determination unit determines that the control program is installed in the information processing apparatus, the first installation unit registers the application program into the information processing apparatus by using information stored in the device information storage unit, regarding that the application program is an application program which is activated in response to the event; and
wherein, in a case where the installation determination unit determines that the control program is not installed in the information processing apparatus, the second installation unit registers the application program into the information processing apparatus according to a specification defined by the operating system, regarding that the application program is an application program which is activated in response to the event.

2. The information processing apparatus according to claim 1, wherein the first installation unit includes the device information storage unit and the installation determination unit.

3. The information processing apparatus according to claim 1,
wherein the first installation unit further includes a registration determination unit configured to determine whether or not the application program which is activated in response to the same event is registered in the information processing apparatus; and
wherein, in a case where the registration determination unit determines that the application program is registered, the application program is registered into the information processing apparatus regarding that the application program is the application program which is activated in response to the event notified from the event notification unit.

4. The information processing apparatus according to claim 3,
wherein the first installation unit further includes an update determination unit configured to determine whether or not registration of the application program which is activated in response to the event registered in the information processing apparatus can be updated; and
wherein, in a case where the registration determination unit determines that the application program is registered and the update determination unit determines that the updating thereof is possible, the application program is registered in the information processing apparatus as the application program which is activated in response to the event notified from the event notification unit.

5. A control method of an information processing apparatus, which is connectable to an image input device and activates an application program according to an event generated by an operation of a user in the image input device by installation of the application program and a control program, and in which the control program controls the image input device according to an instruction of the application program, the control method comprising:
storing device information that holds information as to the image input device to which the application program is applicable;
installing the application program onto an operating system of the information processing apparatus;
installing the control program onto the operating system of the information processing apparatus; and
determining whether or not the control program is installed in the information processing apparatus when the application program is installed;
wherein, in a case where it is determined that the control program is installed in the information processing apparatus, the application program is registered in the information processing apparatus by using the stored device information, regarding that the application program is an application program which is activated in response to an event notified from the event notification unit; and
wherein, in a case where it is determined that the control program is not installed in the information processing apparatus, the application program is registered in the information processing apparatus according to a specification defined by the operating system, regarding that the application program is the application program which is activated in response to the event.

6. A computer-readable storage medium storing a program for causing a computer to execute a control of an information processing apparatus, which is connectable to an image input device and activates the application program in response to an event generated by an operation of a user in the image input device by installation of the application program and a control program, and in which the control program controls the image input device according to an instruction of the application program, the control comprising,
installing the application program onto an operating system of the information processing apparatus;
installing the control program onto the operating system of the information processing apparatus;
storing image input device information that holds information as to the image input device to which the application program is applicable; and
determining whether or not the control program is installed in the information processing apparatus when the application program is installed;
wherein, in a case where it is determined that the control program is installed in the information processing apparatus, the application program is registered in the information processing apparatus by using the stored device information, regarding that the application program is an application program which is activated in response to an event notified from the event notification unit; and
wherein, in a case where it is determined that the control program is not installed in the information processing apparatus, the application program is registered in the information processing apparatus according to a specification defined by the operating system, regarding that the application program is the application program which is activated in response to the event.
